(19) United States
(12) Patent Application Publication
(10) Pub. No.: US 2004/0174698 A1
(43) Pub. Date: Sep. 9, 2004

(54) Light pen and presentation system having the same

(75) Inventors: Takashi Nagashima, Saitama (JP); Mitsuyoshi Nishimura, Saitama (JP)

Correspondence Address: OLIFF & BERRIDGE, PLC, P.O. BOX 19928, ALEXANDRIA, VA, 22320, US

(73) Assignee: FUJI PHOTO OPTICAL CO., LTD., Saitama-shi (JP)

(21) Appl. No.: 10/802,944

(22) Filed: Mar. 18, 2004

(30) Foreign Application Priority Data
May 8, 2002 (JP) 2002-132327
Jun. 14, 2002 (JP) 2002-174184
Jun. 27, 2002 (JP) 2002-187111
Sep. 26, 2002 (JP) 2002-281208
Oct. 2, 2002 (JP) 2002-289402
Mar. 31, 2003 (JP) 2003-094271
Mar. 27, 2003 (JP) 2003-087542

(51) Int. Cl. B43K 29/00

(52) U.S. Cl. 362/118; 362/202; 362/208; 362/205; 362/119

(57) ABSTRACT

The present invention provides a light pen having a rod-like body portion, a leading end portion removably mounted to the body, an emitter for emitting light and a switch for turning the emitter ON and OFF. The emitter and the switch are provided at the leading end portion.

### BACKGROUND OF THE INVENTION

1. Field of the Invention

The present invention relates to a light pen and a presentation system in which the light pen is used as a pointing device for performing a pointing operation on a virtual screen virtually generated by a material presentation apparatus.

2. Description of the Related Art

A light pen is an input device constructed such that when a tip end is pressed, a switch is turned ON, a light bulb at the tip end emits light, a tablet detects the light emitted by the light bulb and the contact of the tip end, and a mouse signal is transmitted to a computer, for example, as shown in Japanese Patent Unexamined Application Publication No. 2000-132327.

In recent years, a material presentation apparatus for presentations has been proposed as described below. The material presentation apparatus is constructed such that a material is photographed and a photographed image of the material is displayed on a display device such as a screen. In presentations, laser pointers emitting laser beams were commonly used as pointing operation devices. However, the laser beams were dangerous, and thereby other pointing devices are desired. It was therefore thought that the above input device (pen-type pointing device) as shown in the above Japanese Patent Unexamined Application Publication No. 2000-132327 could be employed with the material presentation apparatus. The input device is equipped with a recognizing device which recognizes a contact point of a pen with a flat tablet as coordinates and another recognizing device recognizing whether the pen emits light or not and the coordinates of the spot at which light is emitted. Due to this, the input device has a complicated structure and is expensive. Since a combination of the tablet and the pen is necessary for the input device, and the input device cannot be used when either of them malfunctions. In particular, it is difficult to repair the tablet.

### SUMMARY OF THE INVENTION

Objects of the present invention are to provide a light pen which can be reliably used as a pointing device, is inexpensive and is easily repaired, and to provide a presentation system in which the light pen is used as a pointing device for a material presentation apparatus.

The present invention provides a light pen comprising: a rod-like body portion; a leading end portion removably mounted to the body; an emitter for emitting light; and a switch for turning the emitter ON and OFF, the emitter and the switch being provided at the leading end portion.

According to the light pen of the present invention, since the emitter and the switch are provided in the leading end portion, when either of them malfunctions, the leading end portion is simply replaced with a new one. As a result, the light pen is inexpensively repaired instead of replacing the entire light pen. The leading end portion can be replaced by one composed of a desired LED of which the shape and the color of emitted light can be varied.

In the light pen of the present invention, the leading end portion may be disassemblable and may comprise a light emitting portion in which the emitter is provided and a switch portion in which the switch is provided. According to the embodiment, when either the emitter or the switch malfunctions, either the light emitting portion or the switch portion may be replaced with a new one, and the replacement can thereby be less expensive. The light emitting portion may comprise a current controlled element in addition to the above LED (light emitting element).

The light pen of the present invention can be constructed such that, when the leading end portion is pressed in a predetermined direction, the switch is turned ON, and, when the leading end portion is not pressed in the predetermined direction, the switch is turned OFF. The light pen may further comprise a power source provided in the body portion thereof.

The present invention provides a presentation system comprising: a material presentation apparatus; and a light pen, the material presentation apparatus comprising: a material mounting pedestal having a mounting surface on which a material is mounted and a virtual screen is virtually generated; a photographing section, supported on the material mounting pedestal via a support member, and for photographing the material; an image output section for outputting an image photographed by the photographing section to a display device; and a control section for executing image processing, the light pen comprising: a rod-like body portion; a leading end portion removably mounted to the body; an emitter for emitting light on the virtual screen generated by the material presentation apparatus; and a switch for turning the emitter ON and OFF, the emitter and the switch being provided at the leading end portion, wherein the emitter of the light pen emits light on the virtual screen, the emitter is photographed by the photographing section, the control section into which the image photographed by the photographing section is input calculates the coordinates of the position of the emitter and executes a predetermined pointing function at the coordinates on an image on the display device, corresponding to the calculated coordinates of the emitter on the virtual screen. The virtual screen is two-dimensional space on which XY coordinates are generated by image processing and is within the angle of view of the photographing section of the material presentation apparatus.

In the presentation system of the present invention, the emitter of the light pen is turned ON to emit light toward the virtual screen on which is generated on the material mounting pedestal of the material presentation apparatus by having the body portion of the light pen and turning the switch ON. In the state in which the emitter emits light, when emitted light is photographed by the photographing section, the control section into which the image photographed by the photographing section is input calculates the coordinates of the position of the emitter and executes a predetermined pointing function at the coordinates on an image on the display device, corresponding to the coordinates of the emitter on the virtual screen. For example, the pointing function is executed by displaying the point image on the image of the material on the display device.

According to the presentation system of the present invention, the control section detects the position of the emitter via the photographing section of the material presentation apparatus, thereby executing a predetermined pointing function at the image displayed on the display device. Therefore, the light pen can be designed more simply than conventional pen-type pointing devices equipped with a tablet, and it is thereby inexpensive. There is no danger of projecting laser beams as erroneously with laser pointers, whereby pointing operations can be safely performed with respect to displayed images.

In the presentation system of the present invention, the emitter of the light pen may emit light including light of a specific wavelength and the material presentation apparatus may further comprise an optical filter which is removably provided in a photographing optical path of the photographing section and which allows the photographing section to photograph only the light of a specific wavelength. In this case, since the photographing section photographs only the emitter, the control section can reliably detect the emitter, and reliable actions of the material presentation apparatus can be obtained.

In the presentation system of the present invention, the material presentation apparatus may further comprise a monitor displaying an image photographed by the photographing section or another image. In this case, the photographing section may be provided so as to photograph the photographing section and the virtual screen may be virtually generated on the monitor, whereby the light pen can point on the monitor by emitting light in the same manner as described above.

### BRIEF DESCRIPTION OF THE DRAWINGS

FIG. 1 is a schematic perspective diagram of a light pen and a material presentation apparatus for a presentation system in an embodiment according to the present invention;

FIG. 2 is a functional block diagram schematically showing structure and function of the material presentation apparatus shown in FIG. 1;

FIG. 3 is a perspective diagram of the disassembled light pen in the embodiment according to the present invention;

FIG. 4A is a cross section of the light pen shown in FIG. 3, and FIG. 4B is a circuit diagram of the light pen shown in FIG. 3;

FIG. 5 is a perspective diagram of a disassembled leading end portion of a light pen according to another embodiment of the present invention; and

FIG. 6 is a cross section of the leading end portion shown in FIG. 5.

### DESCRIPTION OF THE PREFERRED EMBODIMENTS

Embodiments of the present invention will be described hereinafter with reference to the drawings.

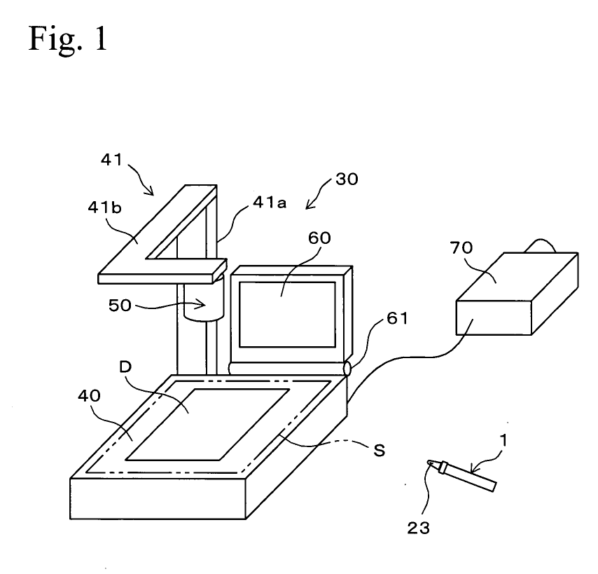

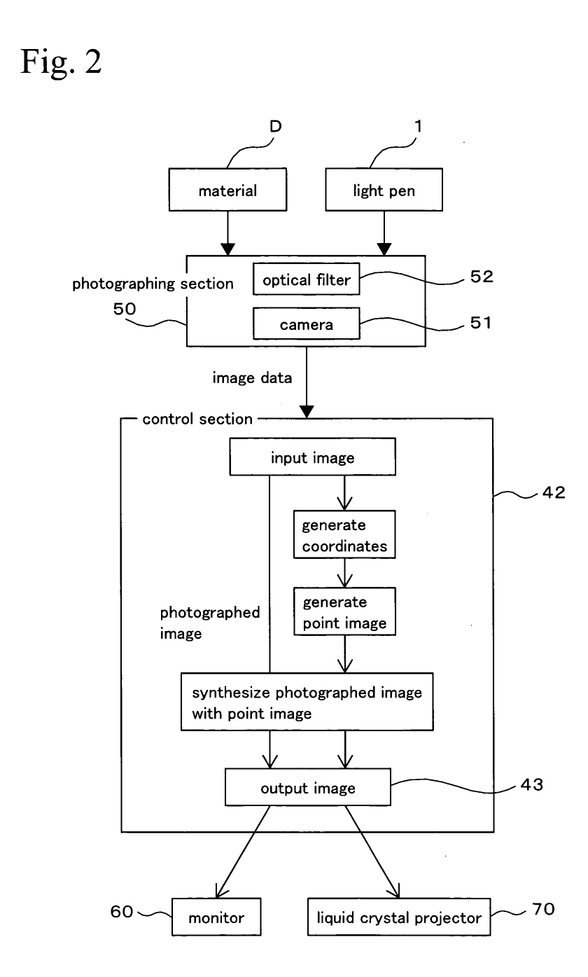

FIG. 1 is a schematic perspective diagram of a light pen 1 and a material presentation apparatus 30 for a presentation system in an embodiment. FIG. 2 is a functional block diagram schematically showing structure and function of the material presentation apparatus 30 shown in FIG. 1. As shown in FIG. 1, the material presentation apparatus 30 is equipped with a material mounting pedestal 40 on which a material D is mounted, a photographing section 50 supported on the material mounting pedestal 40 via an arm (support member) 41, and a monitor 60 for a presenter. The arm 41 is composed of a support portion 41a vertically provided at the left back end portion of the material mounting pedestal 40 and a horizontal portion 41b fixed on the upper end portion of the support portion 41a. The horizontal portion 41b has an L-shape. The leading end of the horizontal portion 41b is positioned approximately at the center of the material mounting pedestal 40. A photographing section 50 for photographing the material D is mounted to the leading end of the horizontal portion 41b.

A monitor 60 is mounted to the back end portion of the material mounting pedestal 40 via a hinge mechanism 61 so as to be openable and closable. FIG. 1 shows an open state of the monitor 60. In the open state of the monitor 60, the screen thereof faces forward and is viewed by a user (presenter). The open angle of the monitor 60 can be appropriately adjusted by hand.

As shown in FIG. 2, the photographing section 50 is equipped with a camera 51 and an optical filter 52. The camera 51 has a zoom function and an automatic focus function. The optical filter 52 allows the camera 51 to photograph only infrared light. The optical filter 22 is removably provided in the photographing optical path of the camera 51 by hand. As shown in FIG. 2, an image photographed by the photographing section 50 is input into a control section 42 and is processed thereby. The photographed image processed by the control section 42 is output from an image output section 43 of the control section 42 to the monitor 60 and a liquid crystal projector 70. The photographed image is projected from the liquid crystal projector 70 to a screen (not shown). The control section 42 is, for example, provided in the material mounting pedestal 40. The photographing section 50 may be rotatably mounted to the arm 41 so as to photograph the monitor 60.

The control section 42 generates XY coordinates of a virtual screen S by using standard image processing. The virtual screen S is generated on the surface of the material mounting pedestal 40 photographed by the photographing section 50. The method of virtually generating the virtual screen S is as follows. That is, infrared light is emitted at four corner points of the material mounting pedestal 40, these points at which light is emitted are photographed by the photographing section 50 in a state in which the optical filter 52 is provided in the photographing optical path of the camera 51, and the positions of the points at which light is emitted are detected based on image data obtained by the photographing section 50.

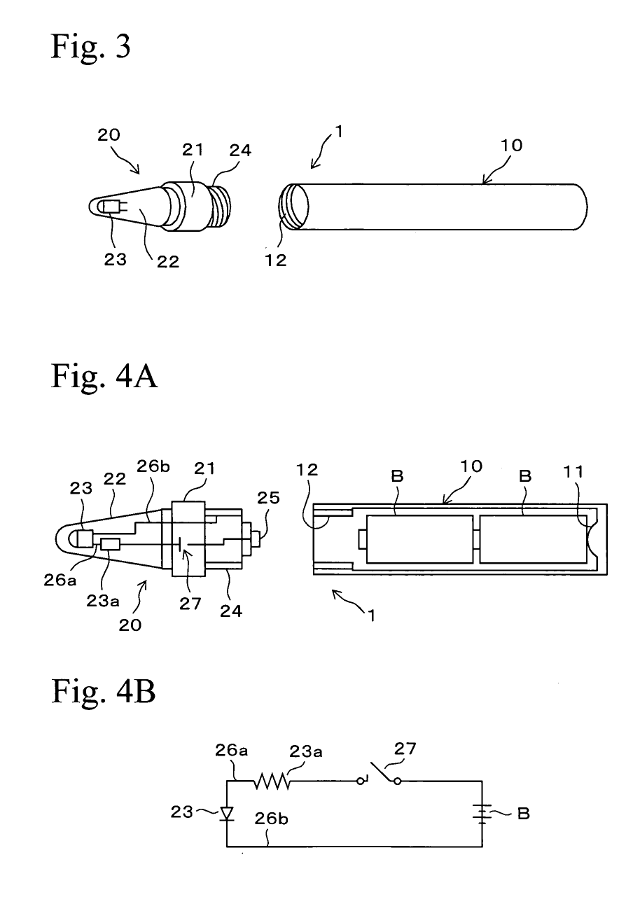

The light pen 1 is used for pointing to the image displayed on the monitor 60 and the screen in the same manner as with laser pointers. As shown in FIGS. 3 and 4A, the light pen 1 is composed of a long and narrow cylindrical body portion 10 and a leading end portion 20 mounted to the tip end (left side in FIGS. 3 and 4A) of the body portion 10.

Plural batteries (power sources) B are provided in the body portion 10. In this case, the number of batteries is two. The batteries are connected in series and the positive electrode thereof is directed toward the opening side. A contact point 11 contacting the negative electrode of the battery B is formed at the bottom face of the body portion 10. A female screw portion 12 is formed as a negative side contact point at the inside face of the opening edge of the body portion 10.

The leading end portion 20 are equipped with a narrow cylindrical housing (switch portion) 21, a conical cap (light emitting portion) 22, LED (emitter) 23, and a current controlled element 23a. The cap 22 is slidably provided at the leading end side of the housing 21 in an axial direction thereof. The cap 22 is ordinarily biased by a spring (not shown) provided in the housing 21 in a tip end direction. The cap 22 is made of transparent resin. The LED 23 is provided in the tip end of the cap 22. The LED 23 is composed of an emitter emitting light including infrared light. The current controlled element 23a is composed of a resistor limiting current to an optimal value. The LED 23 and the current controlled element 23a are molded of resin in the cap 22. A male screw portion 24 is formed on the outside face of the end portion of the housing 21 opposite to the side in which the cap 22 is screwed. The male screw portion 24 is set as a negative side contact point. As shown in FIG. 4A, a positive side contact point 25 is provided at the center of the end face of the housing 21 at which the male screw portion 24 is formed.

As shown in FIGS. 4A and 4B, current lines 26a and 26b are connected to the positive side and the negative side of the LED 23. The current line 26a of the positive side is connected to the positive side contact point 25 via a press-type switch 27 provided in the housing 21. The current line 26b of the negative side is connected to the male screw portion 24. The current controlled element 23a is placed at the positive side current line 26a between the LED 23 and the switch 27. In the switch 27, when the cap 22 is pressed toward the housing 21 against the force biased by the spring, the cap is connected to the housing 21 and the switch 27 is turned ON. On the other hand, when the cap 22 is not pressing toward the housing 21, and the cap is separated from the housing 21, the cap is thereby returned to the initial position and the switch 27 is turned OFF.

The light pen of the embodiment is assembled by screwing the male screw portion 24 of the leading end portion 20 to the female screw portion 12 of the body portion 10 in which the batteries B are provided. In this assembled state of the light pen 1, the positive side contact point 25 of the leading end portion 20 contacts with the positive electrode of battery B of the leading side, and the negative electrode of the battery B of the bottom portion side contacts with the negative side contact point 11 of the body portion 10. The female screw portion 12 of the body portion 10 as a negative side contact point and the male screw 24 of the leading end portion 20 contact with each other. As a result, a series circuit is formed as shown in FIG. 4B. A light emitting diode unit in which the current controlled element 23a is provided and is packed is more favorably used as the above LED 23.

In the use of the light pen 1, the body portion 10 is held and the tip end of the light pen 1(leading end portion 20) is pressed on an object having more than some degree of hardness. As a result, the body portion 10 and the housing 21 move toward the leading end, the switch 27 is turned ON, and the LED 23 emits light. When the pressing force on the object is relieved, the body portion 10 and the housing 21 return to the initial state and the switch 27 is turned OFF, and the LED 23 thereby stops emitting light.

An example of use of the light pen 1 and the material presentation apparatus 30 in the presentation system, and actions thereof are described hereinafter.

The optical filter 52 is removed from the photographing optical path of the camera 51, and the photographing section 50 photographs the material D. An image of the material D photographed by the photographing section 50 is processed as a static image, and the static image of the material D is displayed on the monitor 60 and the screen. The static image processing is executed by the control section 42 when a predetermined command signal is input thereinto. The optical filter 52 is placed in the photographing optical path of the camera 51, and the user presses the tip end of the light pen 1 on a required position on the material D so that the LED 23 emits light. As a result, an image of the LED is input into the control section 42 via the photographing section 50. The control section 42 calculates the position of the LED 23, that is, the coordinates of the LED 23 on the virtual screen S and synthesizes a predetermined point image with the image displayed on the monitor 60 and the screen at the coordinates corresponding to the calculated coordinates on the virtual screen S. Therefore, the user can perform a pointing operation on the image of the material D.

According to the embodiment, the light pen 1 is pressed on the material D and emits light so as to indicate the material D, whereby pointing operations are performed on the image on the monitor 60 and the screen. Therefore, the light pen 1 can be designed more simply than conventional pen-type pointing devices equipped with a tablet, and it is thereby inexpensive. There is no danger of projecting laser beams erroneously in the case of laser pointers, whereby pointing operations can be safely performed with respect to displayed images. When the light pen 1 emits light so as to point to the material D, the optical filter 52 is placed in the photographing optical path of the camera 51, whereby the photographing section 50 photographs only the LED 23, the control section 42 can reliably recognize the LED 23 and reliable actions of the material presentation apparatus can be obtained.

In addition, since the LED 23 and the switch 27 are provided in the leading end portion 20, when one of the LED 23, the switch 27 and the wire (the current line 26a and 26b) malfunctions at least, the leading end portion 20 is simply replaced with a new one. As a result, the light pen is repaired. When the shape and the color of LED 23 are varied, the leading end portion may be replaced with one composed of a desired LED.

The photographing section 50 may be provided so as to photograph the photographing section 50 and the virtual screen may be virtually generated on the monitor 60, whereby the light pen 1 can point on the monitor 60 by emitting light in the same manner as described above instead of generating the virtual screen on the material mounting pedestal 40 as the above example of use of the light pen 1.

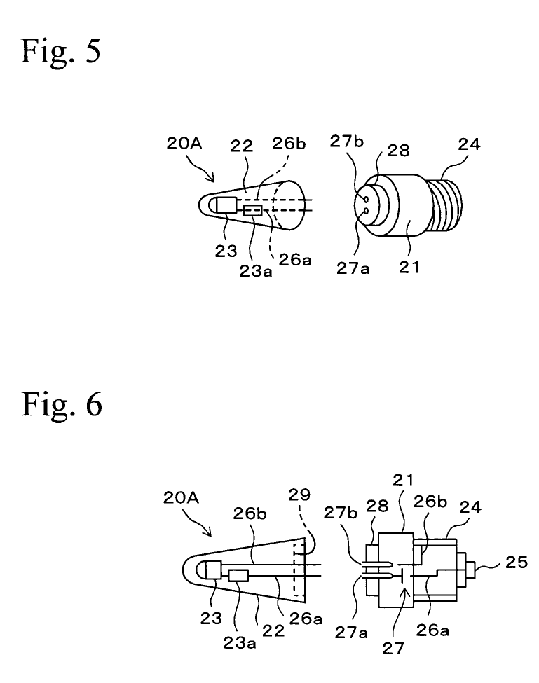

FIGS. 5 and 6 show another embodiment of the above leading end portion 20. That is, a leading end portion 20A is constructed such that the cap 22 in which the LED 23 and the current controlled element 23a are provided is fit in the housing 21 so as to be disassemblable. In this case, as shown in FIG. 6, a recessed portion 29 formed at the inside face of the opening edge of the cap 22 is removably provided in a protrusion portion 28 formed at the end face on the leading end side of the housing 21. When the cap 22 is fit in the housing 21, the current lines 26a and 26b of the LED 23 are inserted in terminals 27a and 27b connected to the current lines 26a and 26b of the housing 21 and connected thereto. According to another embodiment, when either the LED 23 or the switch 27 malfunctions, either the LED 23 or the switch 27 may be replaced with a new one, and the replacement can be less expensive.

Although in the above embodiment the switch 27 of the above light pen 1 is of the press-type construction so as to be turned ON when the tip end of the light pen 1 is pressed, the switch is not limited to the above embodiment. For example, the present invention can be applied to a rotation-type switch or push button-type switch. Although the LED 23 is used as an emitter in the above embodiment, the emitter is not limited to the above embodiment. For example, a simple bulb can be used as the emitter. In the present invention, the emitter and the switch are provided at the leading end portion, and the leading end portion is removably mounted to the body portions.

What is claimed is:

1. A light pen comprising:
a rod-like body portion;
a leading end portion removably mounted to the body;
an emitter for emitting light; and
a switch for turning the emitter ON and OFF, the emitter and the switch being provided at the leading end portion.

2. The light pen according to claim 1, wherein the leading end portion disassemblably comprises:
a light emitting portion in which the emitter is provided; and
a switch portion in which the switch is provided.

3. The light pen according to claim 2, wherein the light emitting portion comprises:
a light emitting element; and
a current controlled element.

4. The light pen according to claim 1, wherein the leading end portion is pressed in a predetermined direction, whereby the switch is turned ON.

5. The light pen according to claim 1, wherein the light pen further comprising:
a power source for the emitter, which is provided in the body portion.

6. A presentation system comprising:
a material presentation apparatus; and
a light pen,
the material presentation apparatus comprising:
a material mounting pedestal having a mounting surface on which a material is mounted and a virtual screen is virtually generated;
a photographing section supported on the material mounting pedestal via a support member and for photographing the material;
an image output section for outputting an image photographed by the photographing section to a display device; and
a control section for executing image processing, the light pen comprising:
a rod-like body portion;
a leading end portion removably mounted to the body;
an emitter for emitting light on the virtual screen generated by the material presentation apparatus; and
a switch for turning the emitter to ON and OFF, the emitter and the switch being provided at the leading end portion,
wherein the emitter of the light pen emits light on the virtual screen, the emitter is photographed by the photographing section, the control section into which the image photographed by the photographing section is input calculates coordinates of the position of the emitter and executes a predetermined pointing function at the coordinates on an image on the display device, corresponding to the calculated coordinates of the emitter on the virtual screen.

7. The presentation system comprising according to claim 6, wherein the emitter emits light including light of a specific wavelength, and
the material presentation apparatus further comprises:
an optical filter removably provided in a photographing optical path of the photographing section, the optical filter allowing the photographing section to photograph only the light of a specific wavelength.

8. The presentation system according to claim 6, wherein the material presentation apparatus further comprises:
a monitor displaying an image photographed by the photographing section or another image,
wherein the virtual screen is set on the monitor, and the photographing section is provided so as to photograph the monitor.
